(19) United States
(12) Patent Application Publication
(10) Pub. No.: US 2017/0244893 A1
(43) Pub. Date: Aug. 24, 2017

(54) METHOD FOR OBTAINING IMAGE AND IMAGE PICKUP DEVICE AND ELECTRONIC DEVICE USING THE SAME

(71) Applicant: Primax Electronics Ltd., Neihu (TW)

(72) Inventor: JUI-TING CHIEN, Neihu (TW)

(21) Appl. No.: 15/088,682

(22) Filed: Apr. 1, 2016

(30) Foreign Application Priority Data
Feb. 19, 2016 (TW) 105105026

(51) Int. Cl. H04N 5/232; H04N 5/225

(52) U.S. Cl. CPC H04N 5/23232; H04N 5/23209; H04N 5/2257

(57) ABSTRACT

The present invention provides a method for measuring a depth of field of an image, including: (a) picking up a first image having a first resolution at a first position; (b) driving the optical lens to move to a second position in a direction along a non-optical axis, and picking up a second image having a second resolution at the second position; and (c) synthesizing the first image and the second image, so as to obtain a third image having a third resolution, where the third resolution is greater than the first resolution and the second resolution. In addition, the present invention also provides an image pickup device and an electronic device using the method.

### FIELD OF THE INVENTION

The present invention relates to the field of image optics, and more particularly to a method for obtaining an image and an image pickup device and an electronic device using the same.

### BACKGROUND OF THE INVENTION

In recent years, with evolution of electronic industries and flourish of industrial technologies, design and development of various electronic devices are oriented to the direction of light and easy to carry, so as to make it convenient for a user to use same in mobile business, entertainment or recreation, and the like anytime and anywhere. For example, various image pickup devices are widely used in various fields, for example, in electronic devices such as smart phones, wearable electronic devices, and air shoot devices, which have advantages of having a small volume and being easy to carry, so that a user can take out the same any time when there is a use demand, to pick up an image and store the image, or further upload the image to the Internet via a mobile network. This not only has a significant commercial value, but also further enriches peoples' daily life. However, with the improvement of life quality, people have more demands for images, and more particularly expect that an obtained image has a higher imaging quality and more imaging effects.

For example, people always expect that the obtained image becomes clearer, and therefore usually increase a resolution of an image by improving a lens or improving a sensing element for imaging, and further may enable a general image to have a better effect through software computing. Referring to FIG. 1, FIG. 1 is a schematic structural diagram illustrating an appearance of an existing smart phone. Two optical lenses 11 and 12 that are arranged in parallel to each other are disposed on a smart phone 1, and the smart phone 1 can photograph the same environment to obtain two images by using the optical lenses 11 and 12, respectively. Although it is impossible for the resolutions of the two images to be superior to that of a high-specification image pickup device such as a single lens reflex camera as there are some technical thresholds and limitations for a sensing element (not shown) of the smart phone 1 in consideration of a cost and volume of the smart phone 1, the mart phone 1 is additionally provided with a computing unit (not shown) that may perform computation on the two images, so as to synthesize the two images into one image having a super-resolution. Moreover, how to synthesize two images to obtain one image having a super-resolution is well known by those ordinarily skilled in the art, which is not described in detail again herein.

However, to dispose two optical lenses on a smart phone for obtaining an image having a high resolution has the following disadvantages: first, the additionally disposed optical lens and a kit thereof lead to increase of a manufacturing cost; second, the additionally disposed optical lens and the kit thereof need to take up a volume, thereby increasing the difficulty for development of smart phones in a trend towards light, thin, short and small. Therefore, there is still room for improvement of the conventional method for obtaining an image.

### SUMMARY OF THE INVENTION

An object of the present invention is to provide a method for obtaining an image, more particularly to a method for obtaining an image having a high resolution by using a single optical lens only, so as to reduce a volume and manufacturing cost of an image pickup device.

Another object of the present invention is to provide an image pickup device and an electronic device using the method for obtaining an image.

In a preferable embodiment, the present invention provides a method for obtaining an image, used in an image pickup device having an optical lens, where the method for obtaining an image includes:

(a) picking up a first image having a first resolution at a first position;

(b) driving the optical lens to move to a second position in a direction along a non-optical axis, and picking up a second image having a second resolution at the second position; and

(c) synthesizing the first image and the second image, so as to obtain a third image having a third resolution, where the third resolution is greater than the first resolution and the second resolution.

In a preferably embodiment, the present invention also provides an image pickup device, including:

an optical lens;

a driving unit, connected to the optical lens, configured to drive the optical lens to move from a first position to a second position in a direction along a non-optical axis;

a sensing element, configured to sense a beam that passes through the optical lens and that is transmitted in the sensing element to obtain a first image having a first resolution when the optical lens is located at the first position, and sense a beam that passes through the optical lens and that is transmitted in the sensing element to obtain a second image having a second resolution when the optical lens is located at the second position; and

a synthesizing unit, connected to the sensing element, configured to synthesize the first image and the second image, so as to obtain a third image having a third resolution, where the third resolution is greater than the first resolution and the second resolution.

In a preferably embodiment, the present invention also provides an electronic device, including:

a housing; and

an image pickup device, disposed in the housing, including:

an optical lens, at least a part of which is exposed out of the housing;

a driving unit, connected to the optical lens, configured to drive the optical lens to move from a first position to a second position in a direction along a non-optical axis;

a sensing element, configured to sense a beam that passes through the optical lens and that is transmitted in the sensing element to obtain a first image having a first resolution when the optical lens is located at the first position, and sense a beam that passes through the optical lens and that is transmitted in the sensing element to obtain a second image having a second resolution when the optical lens is located at the second position; and

a synthesizing unit, connected to the sensing element, configured to synthesize the first image and the second image, so as to obtain a third image having a third resolution, where the third resolution is greater than the first resolution and the second resolution.

### BRIEF DESCRIPTION OF THE DRAWINGS

FIG. 1 is a schematic structural diagram illustrating an appearance of an existing smart phone;

FIG. 2 is a concept schematic diagram illustrating an image pickup device of the present invention according to a preferable embodiment;

FIG. 3 is a flow chart illustrating a preferable method of a method for obtaining an image of the present invention;

FIG. 4 is a concept schematic diagram illustrating actions of an optical lens in the method shown in FIG. 3;

FIG. 5 is a preferable flow chart illustrating step S3 shown in FIG. 3;

FIG. 6A is a preferable concept schematic diagram illustrating a first image in the method shown in FIG. 5;

FIG. 6B is a preferable concept schematic diagram illustrating a second image in the method shown in FIG. 5;

FIG. 6C is a preferable concept schematic diagram illustrating a third image in the method shown in FIG. 5;

FIG. 7 is another preferable flow chart illustrating step S3 shown in FIG. 3;

FIG. 8 is a schematic structural diagram illustrating an appearance of an electronic device of the present invention; and

FIG. 9 is a side elevation illustrating the electronic device shown in FIG. 8.

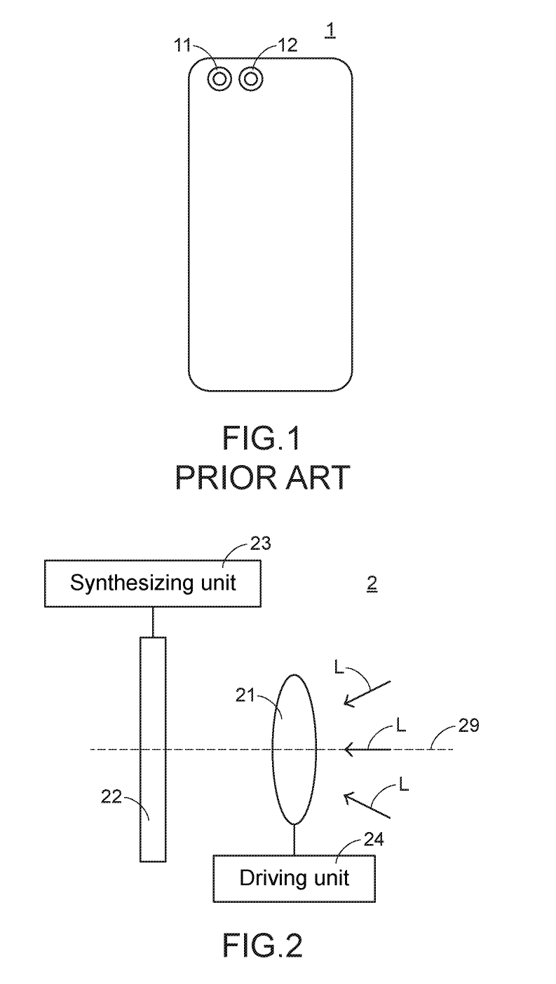

### DETAILED DESCRIPTION OF THE PREFERRED EMBODIMENT

First, an image pickup device of the present invention is illustrated. Referring to FIG. 2, FIG. 2 is a concept schematic diagram illustrating an image pickup device of the present invention according to a preferable embodiment. An image pickup device 2 includes an optical lens 21, a sensing element 22, a synthesizing unit 23, and a driving unit 24. The sensing element 22 is connected to the synthesizing unit 23 and is perpendicular to an optical axis 29. The sensing element 22 is configured to sense a beam L that passes through the optical lens 21 and that is transmitted to the sensing element 22, to obtain an image for analysis and computation by the synthesizing unit 23, and the driving unit 24 is connected to the optical lens 21 and is configured to drive the optical lens 21 to move in a direction D along a non-optical axis (referring to FIG. 4), which are described in detail below. In this preferable embodiment, the driving unit 24 is a motor, and the sensing element 22 is a charge coupled device (CCD) or a complementary metal-oxide-semiconductor (CMOS) element, but the present invention is not limited thereto.

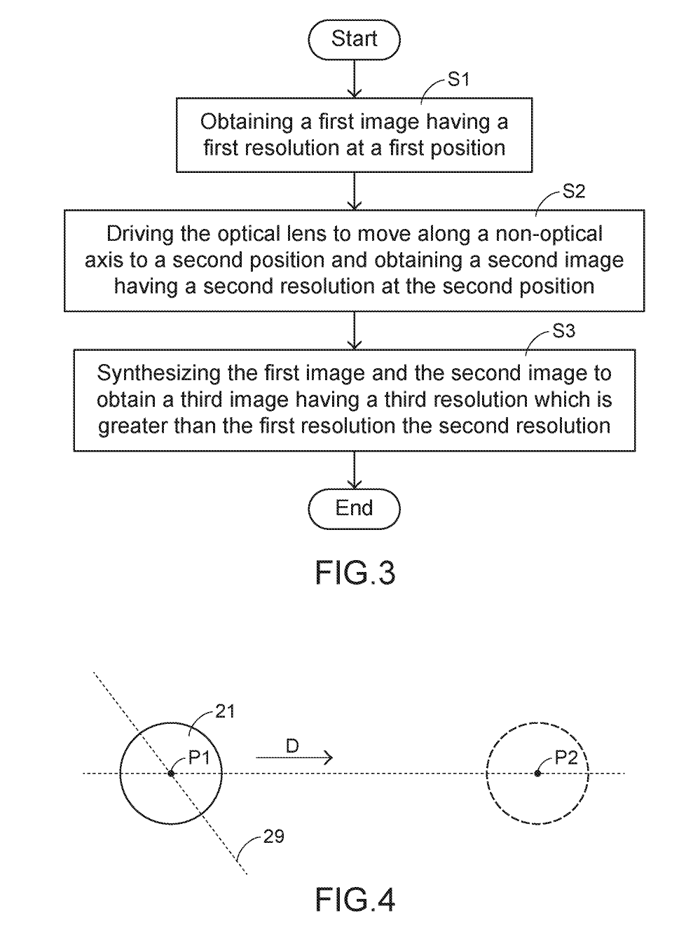

How the image pickup device 2 obtains a high-resolution image is described below. The “resolution” in this specification refers to the number of pixel points included in a unit length, and it determines an elaborate degree of details of a bitmap. Generally, a higher resolution indicates a clearer image. Referring to FIG. 3 and FIG. 4, FIG. 3 is a flow chart illustrating a preferable embodiment of a method for obtaining an image of the present invention, and FIG. 4 is a concept schematic diagram illustrating actions of an optical lens in the method shown in FIG. 3. The method for obtaining an image includes step S1 to step S3. Step S1 to step S3 are separately described in detail below.

Step S1: a beam L that passes through the optical lens 21 and that is transmitted to the sensing element 22 is sensed to obtain a first image having a first resolution when the optical lens 21 is located at a first position P1. Step S2: the optical lens 21 is driven, by the driving unit 24, to move from the first position P1 to a second position P2 in a direction D along a non-optical axis, so that the sensing element 22 senses a beam L that passes through the optical lens 21 and that is transmitted to the sensing element 22 to obtain a second image having a second resolution.

In this preferable embodiment, the first position P1 is spaced from the second position P2 for 3 pixels. Because in the present invention, a beam L that passes through the optical lens 21 and that is transmitted to the sensing element 22 is sensed by using the single sensing element 22 no matter the optical lens 21 is located at the first position P1 or the second position P2, the first resolution of the first image is the same as the second resolution of the second image and the present invention is not limited thereto. For example, two sensing elements may be disposed in an image pickup device, to respectively sense beams that pass through an optical lens and that are transmitted thereto when the optical lens is located at a first position and a second position. Therefore, a first resolution of a first image may be different from a second resolution of a second image. For another example, the distance between the first position P1 and the second position P2 can be any one that enables an optimum interpolation result.

Step S3: the first image and the second image are synthesized by the synthesizing unit 23, so as to obtain a third image having a third resolution, where a third resolution of the third image is greater than the first resolution of the first image and a second resolution of the second image. In addition, in this preferable embodiment, the synthesizing unit 23 synthesizes the first image and the second image by using an image interpolation technology.

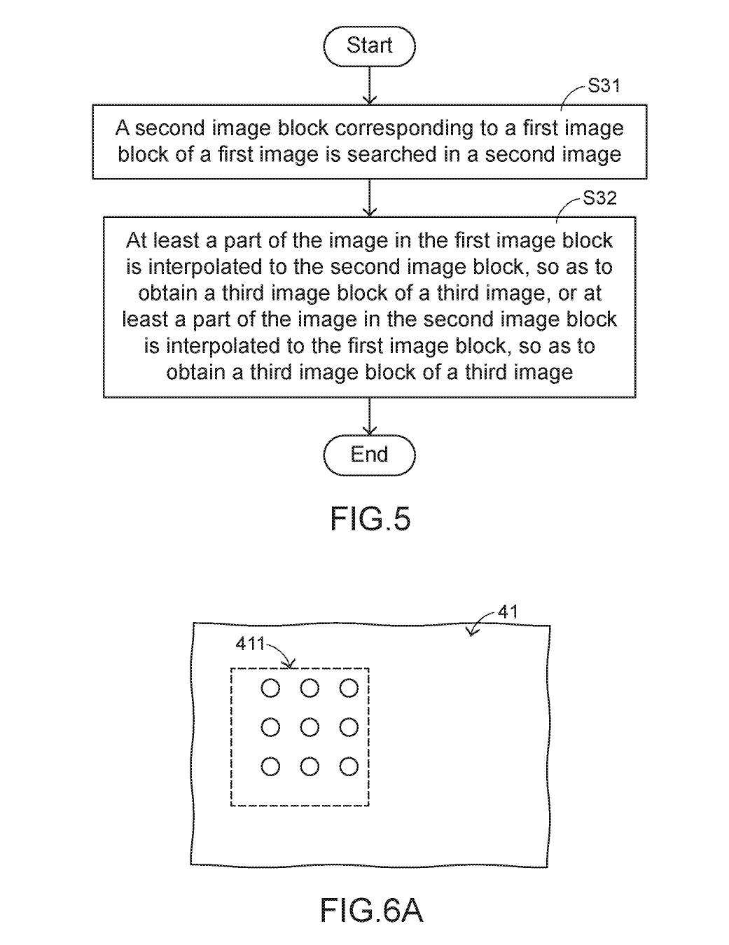

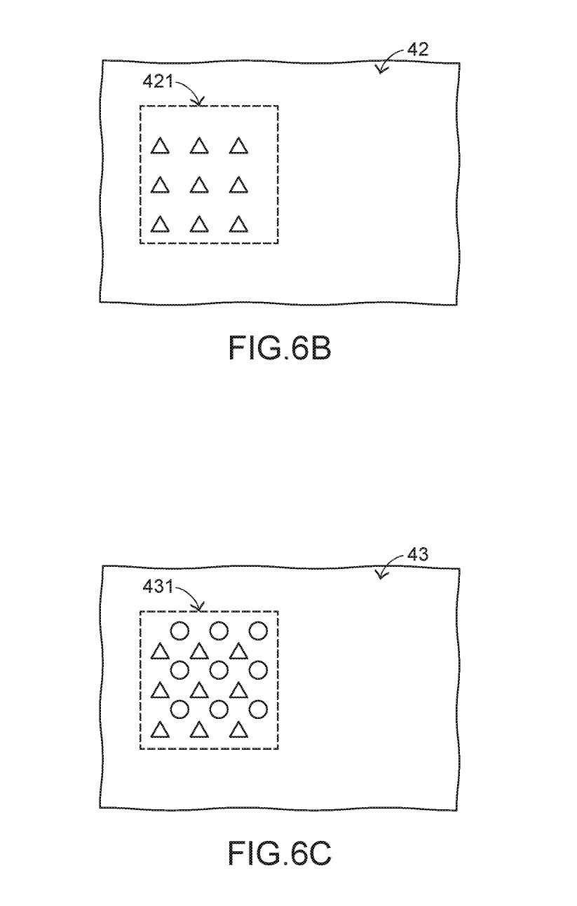

Furthermore, referring to FIG. 5 to FIG. 6C, FIG. 5 is a preferable flow chart illustrating step S3 shown in FIG. 3, FIG. 6A is a preferable concept schematic diagram illustrating a first image in the method shown in FIG. 5, FIG. 6B is a preferable concept schematic diagram illustrating a second image in the method shown in FIG. 5, and FIG. 6C is a preferable concept schematic diagram illustrating a third image in the method shown in FIG. 5. Step S3 includes the following steps. Step S31: a second image block 421 corresponding to a first image block 411 of a first image 41 is searched in a second image 42; and step S32: at least a part of the image in the first image block 411 is interpolated to the second image block 421, so as to obtain a third image block 431 of a third image 43, or at least a part of the image in the second image block 421 is interpolated to the first image block 411, so as to obtain a third image block 431 of a third image 43.

Specifically, in this preferable embodiment, the synthesizing unit 23 searches for a second image block 421 closest to the first image block 411 of the first image 41 in the second image 42 by computing a peak signal-to-noise ratio (PSNR). The peak signal-to-noise ratio can be used to determine whether the second image block 421 of the second image 42 is closest to the first image block 411 of the first image 41, because the peak signal-to-noise ratio is an objective standard for evaluating a similarity degree of two images and a higher peak signal-to-noise ratio indicates a smaller image phase difference.

Further, in the third image 43, in addition to that the third image block 431 is composed of the first image block 411 of the first image 41 and the second image block 421 of the second image 42, any other image block in the third image 43 is also composed of a corresponding image block in the first image 41 and a corresponding image block in the second image 42. Therefore, the third image 43 can retain separate details of the first image 41 and the second image 42. Therefore, the third resolution of the third image 43 is greater than the first resolution of the first image 41 and the second resolution of the second image 42.

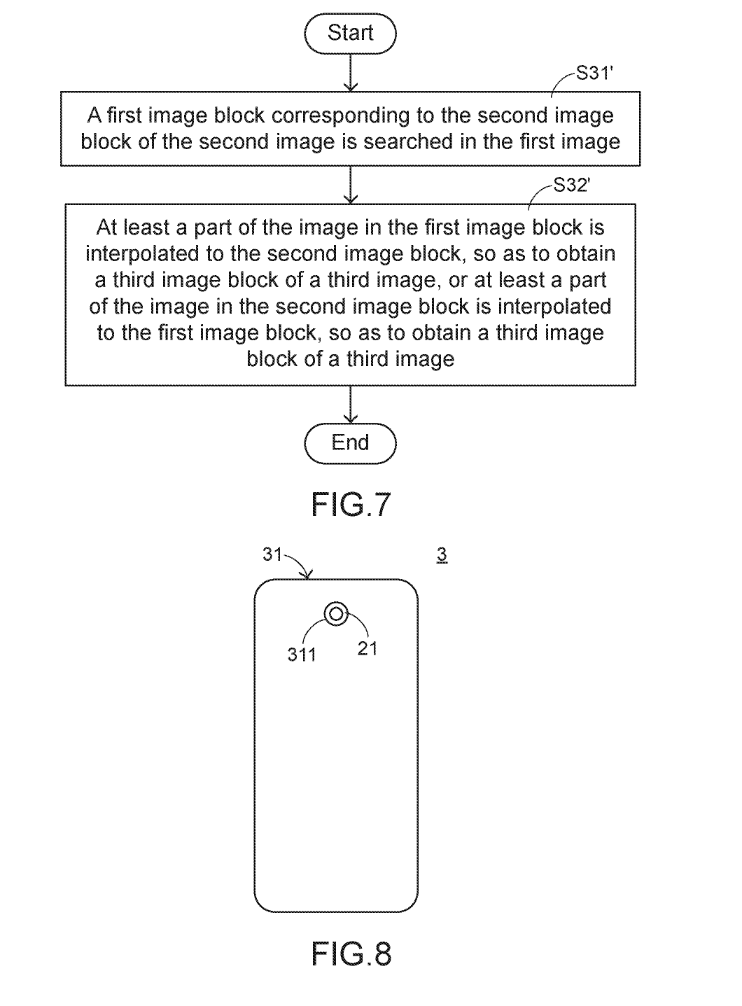

However, the above is only an embodiment, the method for interpolating an image by the synthesizing unit 23 and the method for searching for the second image block 421 closest to the first image block 411 of the first image 41 from the second image 42 are not limited to the above, and those ordinarily skilled in the art could make any equivalent design change according to actual application requirements. For example, the synthesizing unit 23 may further search for the second image block 421 closest to the first image block 411 of the first image 41 from the second image 42 by using a mean-residual normalized correlation method (ZNCC) in addition to computing a peak signal-to-noise ratio. Still for example, the flow of step S3 shown in FIG. 3 may be changed to the steps as shown in FIG. 7. That is, step S3 includes steps S31′ and S32′. Step S31′: a first image block corresponding to the second image block of the second image is searched in the first image; and step S32′: at least a part of the image in the first image block is interpolated to the second image block, so as to obtain a third image block of a third image, or at least a part of the image in the second image block is interpolated to the first image block, so as to obtain a third image block of a third image. Moreover, specific implementation manners related to the image interpolation technology, the peak signal-to-noise ratio, and the mean-residual normalized correlation method are well known by those ordinarily skilled in the art, which are not described in detail again herein.

In addition, the existing image pickup device 2 generally is provided with an optical image stabilization (01S) function. That is, a motion sensor (not shown; for example, a gyro) may be disposed in the image pickup device 2, and the driving unit 24 may drive, according to a sensed result by the motion sensor, the optical lens 21 to move, so as to maintain the optical axis 29 to be perpendicular to the sensing element 22, thereby preventing from photographing a fuzzy image. It needs to be specially noted that if the method for obtaining an image of the present invention is applied to an image pickup device 2 that is originally provided with an optical image stabilization function, the driving unit 24 that is originally disposed in the image pickup device 2 is directly used to drive the optical lens 21 to move from the first position P1 to the second position P2 in the direction D along the non-optical axis in step S2. Therefore, by using the image pickup device 2 that is originally provided with an optical image stabilization function, a high-resolution image can be obtained without additionally disposing a driving unit 2, thereby not increasing the manufacturing cost.

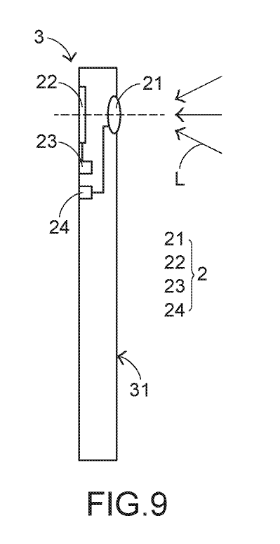

Referring to FIG. 8 and FIG. 9, FIG. 8 is a schematic structural diagram illustrating an appearance of an electronic device of the present invention, and FIG. 9 is a side elevation illustrating the electronic device shown in FIG. 8. The electronic device 3 is, for example, a mobile phone, a personal digital assistant device, or a wearable device (a smart watch, a smart band, or smart glasses), and includes a housing 31 and an image pickup device 2. The housing 31 is provided with a through-hole 311 for exposing the optical lens 21 of the image pickup device 2 outside, so that a beam L outside the housing 31 can be transmitted into the image pickup device 2. The image pickup device 2 of the electronic device 3 shown in FIG. 5 is substantially similar to the one shown in FIG. 2, which is not described in detail again herein.

As can be known from the above, by the method for obtaining an image and the image pickup device and the electronic device using the same, a high-resolution image can be obtained by using a single optical lens only. Therefore, a manufacturing cost of the image pickup device can be effectively reduced, and meanwhile, a volume of the image pickup device may not be increased by a large margin, which is beneficial to development of an electronic device using an image pickup device in a trend towards light, thin, short and small.

The above are only the most preferred embodiments of the present invention, and the present invention needs not be limited to the disclosed embodiments. Therefore, all equivalent changes or modifications included within the spirit and scope of the present invention fall within the scope of the claims of the present invention.

1. A method for obtaining an image, adapted to be used in an image pickup device with an optical image stabilization function, the image pick device having an optical lens, a motion sensor, and a driving unit, wherein the optical image stabilization function causes the driving unit to move the optical lens and maintain an optical axis to be perpendicular to a sensing element according to a sensed result by the motion sensor, wherein the method for obtaining an image comprises:
(a) picking up a first image having a first resolution at a first position;
(b) driving the optical lens with the driving unit to move to a second position in a direction along a non-optical axis, and picking up a second image having a second resolution at the second position; and
(c) synthesizing the first image and the second image, so as to obtain a third image having a third resolution, wherein the third resolution is greater than the first resolution and the second resolution.

2. The method for obtaining an image according to claim 1, wherein the first image and the second image are synthesized into the third image through an image interpolation operation.

3. The method for obtaining an image according to claim 2, wherein the step (c) comprises:
(c-1) searching for a second image block corresponding to a first image block of the first image in the second image, or searching for a first image block corresponding to a second image block of the second image; and
(c-2) interpolating at least a part of the image in the first image block to the second image block, so as to obtain a third image block of the third image, or interpolating at least a part of the image in the second image block to the first image block, so as to obtain a third image block of the third image.

4. The method for obtaining an image according to claim 3, wherein the second image block corresponding to the first image block is obtained by computing a peak signal-to-noise ratio (PSNR), or the first image block corresponding to the second image block is obtained by computing a peak signal-to-noise ratio (PSNR).

5. The method for obtaining an image according to claim 3, wherein the second image block corresponding to the first image block is obtained by using a mean-residual normalized correlation method (ZNCC), or the first image block corresponding to the second image block is obtained by using a mean-residual normalized correlation method (ZNCC).

6. The method for obtaining an image according to claim 5, wherein the first position is spaced from the second position for 3 pixels.

7. An image pickup device, comprising:
an optical lens, a driving unit, a sensing element, and a synthesizing unit, wherein:
the driving unit is connected to the optical lens and is configured to move the optical lens according to a sensed result by a motion sensor, and maintain an optical axis to be perpendicular to the sensing element, and to drive the optical lens to move from a first position to a second position in a direction along a non-optical axis;
the sensing element is configured to sense a beam that passes through the optical lens and that is transmitted in the sensing element to obtain a first image having a first resolution when the optical lens is located at the first position, and sense a beam that passes through the optical lens and that is transmitted in the sensing element to obtain a second image having a second resolution when the optical lens is located at the second position; and
the synthesizing unit is connected to the sensing element and is configured to synthesize the first image and the second image, so as to obtain a third image having a third resolution, wherein the third resolution is greater than the first resolution and the second resolution.

8. The image pickup device according to claim 7, wherein the driving unit is a motor.

9. The image pickup device according to claim 7, wherein the synthesizing unit synthesizes the first image and the second image into the third image by using an image interpolation technology.

10. The image pickup device according to claim 7, wherein the first position is spaced from the second position for 3 pixels.

11. An electronic device, comprising:
a housing; and
an image pickup device, disposed in the housing, comprising an optical lens, a driving unit, a sensing element, and a synthesizing unit, wherein:
at least a part of the optical lens is exposed out of the housing;
the driving unit is connected to the optical lens and is configured to move the optical lens, according to a sensed result by a motion sensor, and maintain an optical axis to be perpendicular to the sensing element, and to drive the optical lens to move from a first position to a second position in a direction along a non-optical axis;
the sensing element is configured to sense a beam that passes through the optical lens and that is transmitted in the sensing element to obtain a first image having a first resolution when the optical lens is located at the first position, and sense a beam that passes through the optical lens and that is transmitted in the sensing element to obtain a second image having a second resolution when the optical lens is located at the second position; and
the synthesizing unit is connected to the sensing element and is configured to synthesize the first image and the second image, so as to obtain a third image having a third resolution, wherein the third resolution is greater than the first resolution and the second resolution.

12. The electronic device according to claim 11, wherein the driving unit is a motor.

13. The electronic device according to claim 11, wherein the synthesizing unit synthesizes the first image and the second image into the third image by using an image interpolation technology.

14. The electronic device according to claim 11, wherein the first position is spaced from the second position for 3 pixels.

15. The electronic device according to claim 11 is a mobile phone, a personal digital assistant device, or a wearable device.
